(19) United States
(12) Patent Application Publication
(10) Pub. No.: US 2008/0086639 A1
(43) Pub. Date: Apr. 10, 2008

(54) PROCESSOR WITH ENCRYPTION FUNCTION, ENCRYPTION DEVICE, ENCRYPTION PROCESSING METHOD, AND COMPUTER READABLE MEDIUM

(75) Inventors: Daisuke KONO, Kanagawa (JP); Ryoji MATSUMURA, Kanagawa (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/747,488

(22) Filed: May 11, 2007

(30) Foreign Application Priority Data
Oct. 10, 2006 (JP) 2006-276025

(51) Int. Cl. H04L 9/32

(52) U.S. Cl. 713/168

(57) ABSTRACT

A processor with encryption function includes: an input unit that inputs a user ID; an embedding unit that embeds the user ID in an authentication password for access to a first external device, the authentication password being contained in processing directive data; an input/output unit that inputs and outputs the processing directive data; an encryption/decryption unit that encrypts the authentication password when outputting the processing directive data, and that decrypts the authentication password when inputting the processing directive data; a processing unit that executes a processing based on processing content which are described in the processing directive data; a collating unit that collates the inputted user ID with the embedded user ID to verify whether or not the inputted user ID and the embedded user ID coincide with each other; and an access unit that controls access to the first external device based on a result of the collating.

### CROSS-REFERENCE TO RELATED APPLICATIONS

This application is based on and claims priority under 35 U.S.C. 119 from Japanese Patent Application No. 2006-276025 filed Oct. 10, 2006.

### BACKGROUND

1. Technical Field

The present invention relates to a processor with encryption function, an encryption device, an encryption processing method, and a computer readable medium.

2. Related Art

There is an art such as an information processor which includes a storage unit for storing security process information on which a security process procedure is described which corresponds to data which contains a structured language handled by application and a security processing unit for performing a security process which includes execution of an encryption process and signing process for the data handled by the application by referring to the security process information from the storage unit for safety communication of the application with an external application using a predetermined communication medium.

### SUMMARY

With a view to attaining the object, according to a mode for carrying out the invention, there are provided a processor with encryption function, an encryption device and a processing program with encryption function which will be described below.

According to an aspect of the present invention, a processor with encryption function includes: an input unit that inputs a user ID; an embedding unit that embeds the user ID in an authentication password for access to a first external device, the authentication password being contained in processing directive data in which a processing content including access to the first external device is described; an input/output unit that inputs and outputs the processing directive data to a second external device in response to a request from the second external device; an encryption/decryption unit that encrypts the authentication password in which the user ID is embedded in a case where the input/output unit outputs the processing directive data, and that decrypts the authentication password in which the user ID is embedded in a case where the input/output unit inputs the processing directive data; a processing unit that executes a processing based on the processing content described in the processing directive data; a collating unit that collates the user ID inputted from the input unit with the user ID embedded in the authentication password in the processing directive data, in a case where the processing is executed, to verify whether or not the inputted user ID and the embedded user ID coincide with each other; and an access unit that accesses the first external device in a case where the user ID inputted from the input unit and the user ID embedded in the authentication password in the processing directive data are determined to coincide with each other.

### BRIEF DESCRIPTION OF THE DRAWINGS

Exemplary embodiment of the present invention will be described in detail based on the following figures, wherein:

FIG. 1 is a conceptual diagram showing an example of a network to which an example of a processor with data encryption function according to an embodiment of the invention;

FIG. 2 is a block diagram showing the configuration of the example of the processor with data encryption function according to the embodiment of the invention;

FIG. 3 is an exemplary diagram showing part of an example of processing directive data which results before a device user ID is embedded according to the embodiment of the invention;

FIG. 4 is an exemplary diagram showing part of processing directive data which results after the device user ID has been embedded according to the embodiment of the invention;

FIG. 5 is an exemplary diagram showing part of an example of processing directive data which is encrypted by a processing directive data encryption and decryption device according to the embodiment of the invention;

FIG. 6 is a flowchart illustrating an example of a flow of creating processing directive data according to the embodiment of the invention;

FIG. 7 is a flowchart illustrating an example of a flow of executing the processing directive data according to the embodiment of the invention;

FIGS. 8A to 8F are conceptual diagrams showing, as a comparison example, an example of a conventional processor with data encryption function and an example of a flow of an illegal operation performed on an administrative external device by an administrative user; and

FIGS. 9A to 9F are conceptual diagrams showing an example of a processor with data encryption function according to the embodiment of the invention and an example of a flow of an illegal operation performed on an administrative external device by an administrative user.

### DETAILED DESCRIPTION

### (Configuration of Processor with Data Encryption Function)

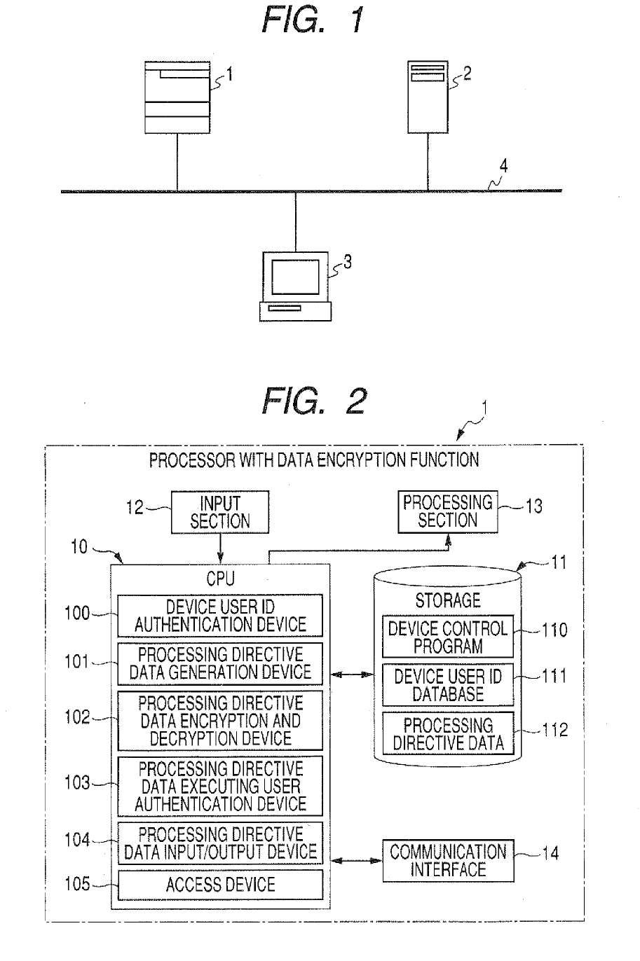

FIG. 1 is a conceptual diagram showing an example of a network to which an example of a processor with data encryption function is connected. As is shown in the figure, a processor with data encryption function 1, an external device 2 and an administrative external device 3 are connected via a network 4. The administrative external device 3 is used by a user who has an administrator authorization (hereinafter, referred to as an administrative user) to perform maintenance and backup operations of data and the like in the processor with data encryption function 1.

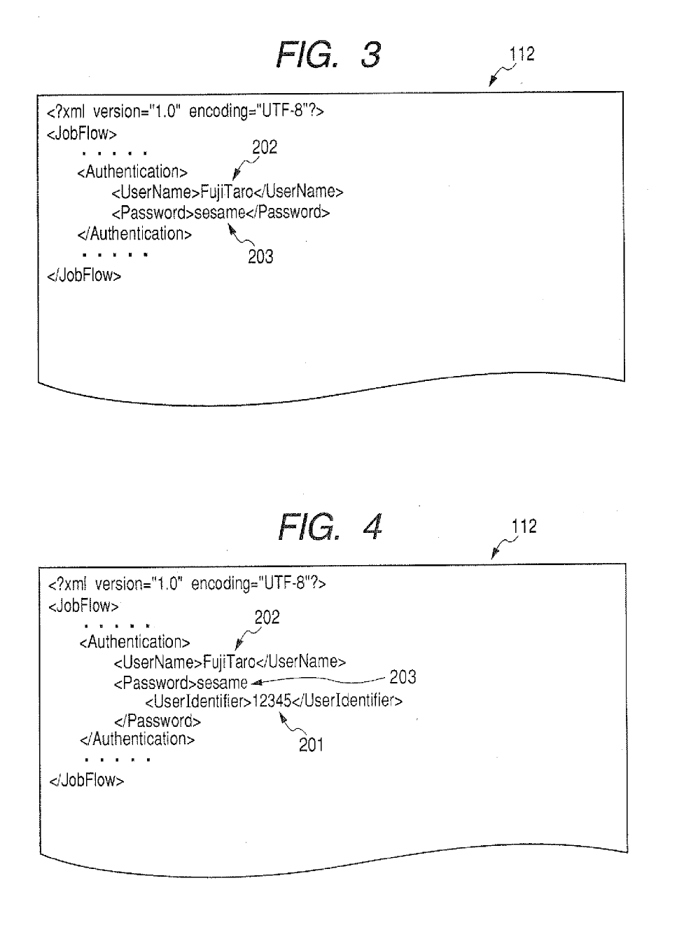

FIG. 2 is a block diagram showing the example of the processor with data encryption function according to the embodiment of the invention. This processor with data encryption function 1 has a CPU 10, a storage which is made up of an HDD or the like which stores various types of program data, an input section 12 including a keyboard, a touch panel and the like, a processing section 13 for performing processes such as printing, scanning, data transmission and the like, and a communication interface (I/F) 14 for establishing a connection with a network. The processor with data encryption function 1 is, for example, multifunction equipment having data encryption function.

The storage 11 stores a device control program 110, a device user ID database 111 and processing directive data 112. In addition, the storage 11 may not be provided within the processor with data encryption function 1 but may be connected to the processor with data encryption function 1 as an external device.

The CPU 10 operates based on the device control program 110 stored in the storage 11 so as to function as a device user ID authentication device 100 for authenticating an inputted device user ID 201, a processing directive data generation device for generating processing directive data 112, an encryption and decryption device 102 for encrypting and decrypting processing directive data 112, a processing directive data executing user authentication device 103 for authenticating a user when the user executes the processing directive data 112, a processing directive data input/output device 104 for inputting/outputting the processing directive data 112 to the administrative external device 3 in response to a request from the administrative external device 3, an access device 105 for accessing the external device 2 based on the process contents described in the processing directive data 112 and the like.

The device user ID authentication device 100 examines whether or not the device user ID 201 inputted from the input section 12 is registered in the device user ID database 111 for authentication.

When a directive to generate processing directive data 112 is given by the user from the input section 12, the processing directive data generation device 101 generates processing directive data 112 and stores it in the storage 11. In addition, the storage 11 can store several pieces of processing directive data 112.

The processing directive data 112 is data specific to each user which describes process contents which include predetermined processes including a process of access to the external device 2 and has information for access to the external device such as the address of the external device, external device user IDs 202 for individual users, external device authentication passwords 203 for individual users, and the like. In addition, the processing directive data 112 is data which is described in a structured language such as XML (Extensible Markup Language), HTML (Hyper Text Markup Language), XHTML (Extensible Hyper Text Markup Language), SGML (Standard Generalized Markup Language) and the like. As the processing directive data 112, for example, a directive statement is raised which describes the process contents of the processor with data encryption function 1.

The process contents described in the processing directive data 112 include, for example, a process of transmitting scanned image data or text data or processing results to an external server of a PC (Personal Computer) for retention, a process of transmitting scanned image data or text data or processing results to a mail server for transmission by electronic mail, a process of transmitting scanned image data or text data or processing results to an FTP (File Transfer Protocol) for transmission and reception through internet, and the like.

The processing directive data generation device 101 embeds an element which contains the device user ID 201 in a password element which contains the external device authentication password 203 as a child element. In addition, the process of embedding the element containing the device user ID 201 in the password element containing the external device authentication password 203 as the child element may be performed by an embedding device which is independent of the processing directive data generation device 101.

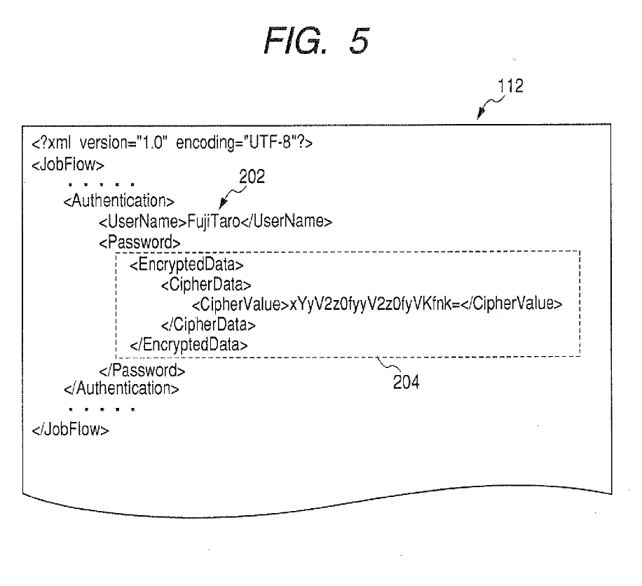

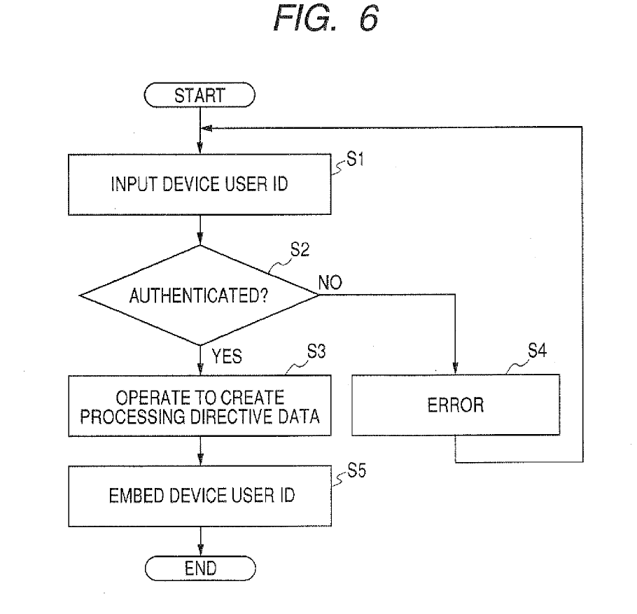

FIG. 3 represents part of an example of processing directive data which results before a device user ID is embedded therein, and FIG. 4 represents part of the processing directive data which results after the device user ID has been embedded therein. As is shown in FIGS. 3 and 4, a Password element which contains “12345” which is the device user ID 201 is embedded in a Password element which contains “sesame” which is the external device authentication password 203. In addition, although it is natural, the “sesame” as the external device authentication password 203, the “12345” as the device user ID and a “Fujitaro” as the external device user ID 202 are only examples, and the password and IDs are not limited thereto.

The processing directive data encryption and decryption device 102 encrypts part of the processing directive data 112 which contains information for access to the external device 2 when the processing directive data 112 is fetched to the administrative external device 2 for maintenance by the administrative user and decrypts the encrypted part when the processing directive data 112 is returned to the processor with data encryption function 1 from the administrative external device 3. The processing directive data 112 is not encrypted in such a state that the data is stored in the storage 11 of the processor with data encryption function 1.

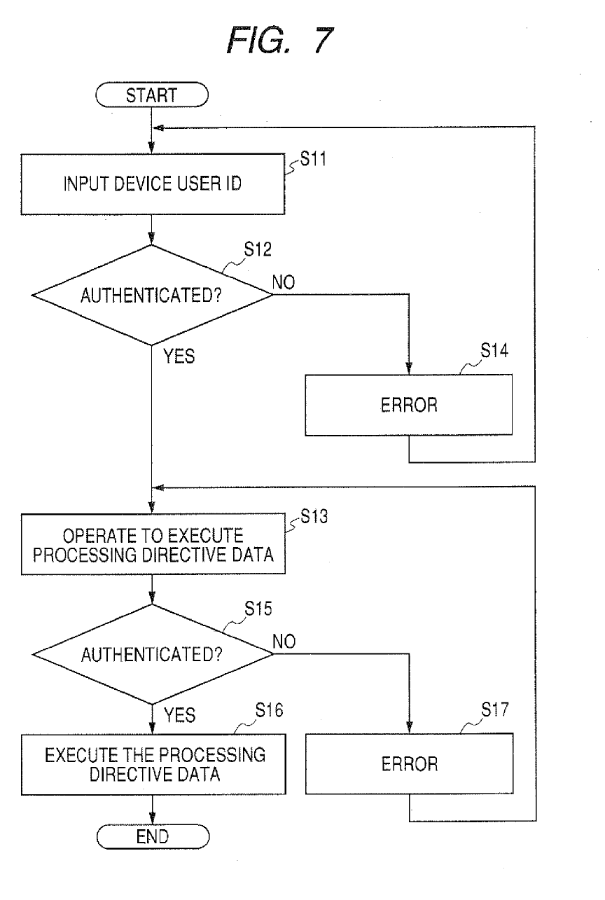

FIG. 5 shows part of processing directive data that has been encrypted by the processing directive data encryption and decryption device. As is shown in FIG. 5, the external device authentication password 203 and the contents of the Password element which contains the device user ID 201 are encrypted into an encrypted part 204. Even in the event that the administrative user reads the processing directive data 112 using reading software or the like in the administrative external device 3 in this state, the administrative user cannot know the external device authentication password 203 and the device user ID 201.

When the user attempts to execute the processing directive data 112, the processing directive data executing user authentication device 103 verifies whether or not a device user ID 201 inputted by the user to use the processor with data encryption function 1 coincides with the device user ID 201 embedded in the processing directive data 112 and authenticates the execution of the processing directive data 112 when both the user IDs 201 are determined to coincide with each other.

The processing directive data input/output device 104 inputs/outputs the processing directive data 112 from the processor with data encryption function 1 relative to the administrative external device 3 when the administrative user performs maintenance or the like.

### (Operation of Processor with Data Encryption Function)

Here, the processor with data encryption function 1 will be described as multifunction equipment. In addition, the processing directive data 112 is regarded as a directive statement which describes a process of “transmitting scanned data to the external device 2 through a network, when a scan is performed by the processor with data encryption function 1.”

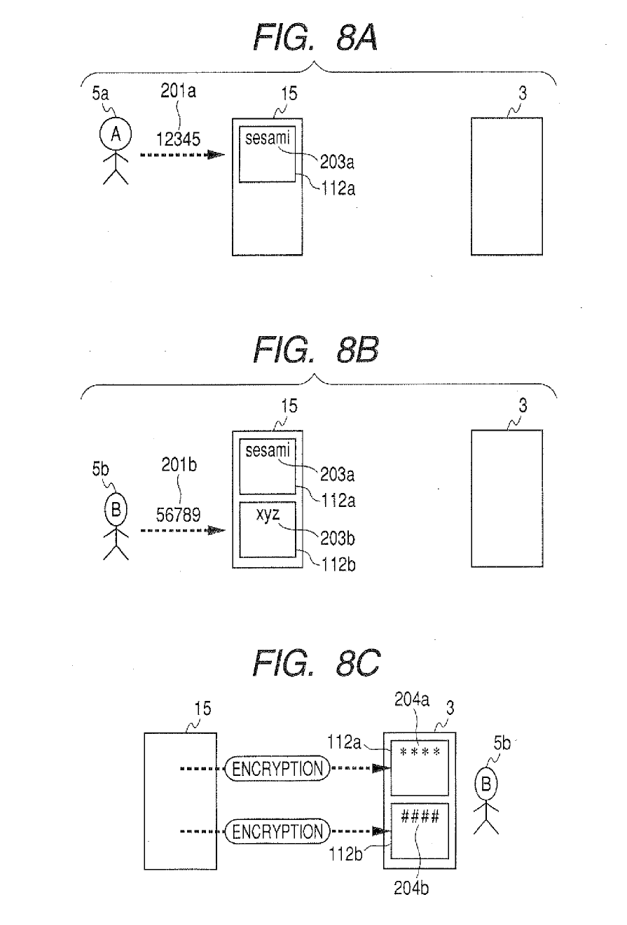

FIG. 6 is a flowchart illustrating an example of a flow of creating processing directive data which is a directive statement. The user creates processing directive data 112 using the processor with data encryption function 1.

Firstly, the user inputs the device user ID 201 from the input section 12 of the processor with data encryption function 1 for use of the processor with data encryption function 1 (step S1 in FIG. 6).

When the device user ID 201 is so inputted, the device user ID authentication device 100 examines whether or not the inputted device user ID 201 has been registered in the device user ID database 111 (step S2 in FIG. 6).

If the device user ID 201 is registered in the device user ID database 111, the use of the process with data encryption function 1 is authenticated, and then the user proceed to create processing directive data 112 which is a directive statement (step S3 in FIG. 6). The user designates a directive content of “sending scanned data to the external device 2 through a network, when scanning is performed by the processor with data encryption function 1” and then inputs the address of the external device 2, the external device user ID 202 which is a user ID for the external device 2 and the external device authentication password 203 which is an authentication password for the external device 2.

On the contrary, if the device user ID 201 is not registered in the device user ID database and hence, the use of the processor with data encryption function 1 is not authenticated, the input is determined as error, and the user is not allowed to proceed with further operations (step S4 in FIG. 6).

Having passed step S3 in FIG. 6, an element which contains the device user ID 201 is embedded in an element which contains the external device authentication password 203 by the processing directive data generation device 101, and the processing directive data 112 shown in FIG. 3 is created (step S5 in FIG. 6).

Next, the processing directive data 112 so created as a directive statement is then executed, and the process content described in the processing directive data 112 is executed.

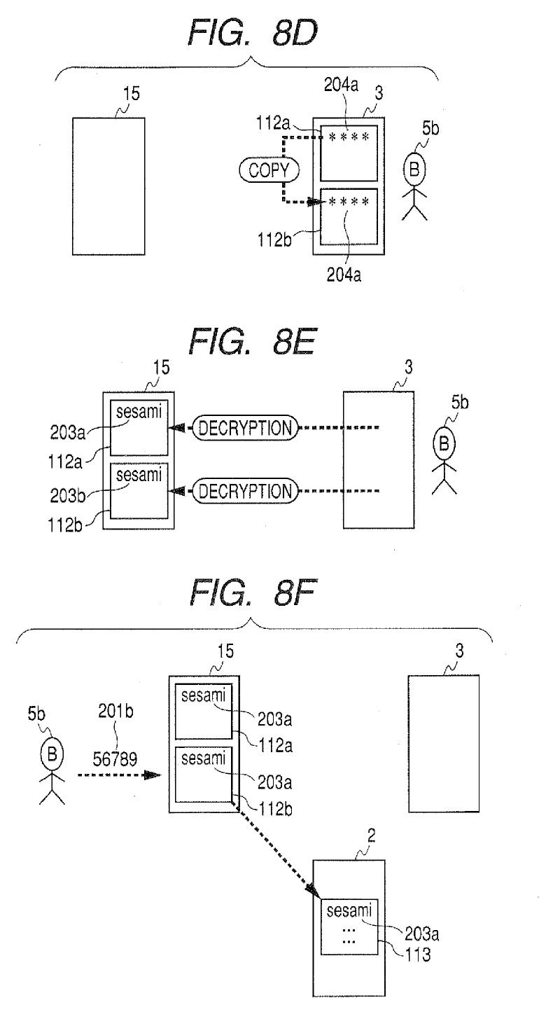

FIG. 7 is a flowchart illustrating an example of a flow of execution of processing directive data by the user. The user inputs the processing directive data 112 using the processor with data encryption function 1.

Firstly, the user inputs the device user ID 201 from the input section 12 of the processor with data encryption function 1 for use of the processor with data encryption function 1 (step S11 in FIG. 7).

When the device user ID 201 is so inputted, the device user ID authentication device 100 examines whether or not the inputted device user ID 201 has been registered in the device user ID database 111 (step S12 in FIG. 7).

If the device user ID 201 is registered in the device user ID database 111, the use of the process with data encryption function 1 is authenticated, and then the user proceed to create processing directive data 112 which is a directive statement (step S13 in FIG. 7).

On the contrary, if the device user ID 201 is not registered in the device user ID database and hence, the use of the processor with data encryption function 1 is not authenticated, the input is determined as error, and the user is not allowed to proceed with further operations (step S14 in FIG. 7).

In step S12 in FIG. 7, when the user operates the input section 12 to execute the processing directive data 112, the processing directive data executing user authentication device 103 verifies whether or not the device user ID 201 inputted by the user in step S11 in FIG. 7 coincides with the device user ID 201 embedded in the processing directive data 112 (step S15 in FIG. 7).

If the inputted device user ID 201 and the device user ID 201 embedded in the processing directive data 112 are determined to coincide with each other, the execution of the processing directive data 112 is authenticated (step S16 in FIG. 7). In this case, a scan of a paper medium is performed by the processing section 13 which has a scanning function of the processor with data encryption function 1, and scanned data is transmitted by the access device 105 to the external device 2 via the communication interface 14 and the network 4. In addition, data sent to the external device 2 is encrypted by an encryption protocol such as SSL (Secure Socket Layer) for transmission.

The scanned data is delivered to the external device 2 based on the address of the external device 2, the external device user ID 202 and the external device authentication password 203 which are described in the processing directive data 112. To be specific, for example, the scanned data is meta data, contains the address of the external device 2, the external device user ID 202 and the external device authentication password 203 and is authenticated by the external device 2.

On the contrary, in step S15 in FIG. 7, if the input device user ID 201 and the device user ID 201 embedded in the processing directive data 112 do not coincide with each other, the execution of the processing directive data 112 is not authenticated, and the input is determined as error (step S17 in FIG. 7).

Next, a flow of performing an unauthorized or illegal operation using processing directive data 112 of another user by making use of the administrator authorization will be described.

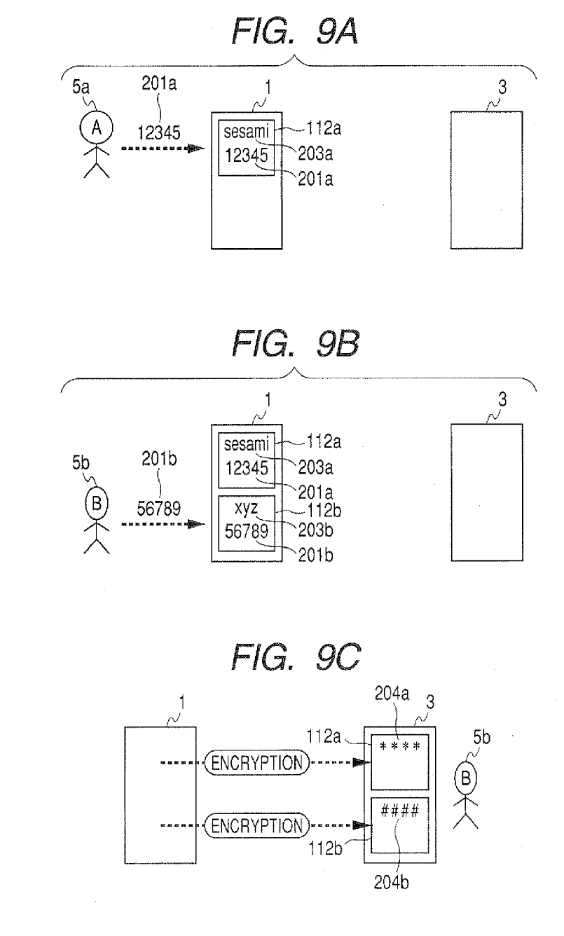

FIGS. 8A to 8F are conceptual diagrams showing, as a comparison example, an example of a conventional processor with data encryption function and a flow of unauthorized or illegal operation on an administrative external device by an administrative user. The administrative user is assumed to perform an authorized or illegal operation using an administrative external device 3 which is connected to a conventional processor with data encryption function 15 via a network 4. Here, the administrative external device 3 is, for example, a PC.

Firstly, as is shown in FIG. 8A, a user A5a inputs a device user ID 201a “12345” of the user A5b to log in to the processor with data encryption function 15 and then creates processing directive data 112a by inputting the address (not shown) of the external device 2, an external device user ID (not shown) of the user A5a and an external device authentication password 203a “sesami” of the user A5a. The information inputted in this way is contained in the processing directive data 12. The processing directive data 112a can be handled only by the user 5Aa in the processor with data encryption function 15.

Next, as is shown in FIG. 8B, a user 5Bb who is an administrative user inputs a device user ID 201b “56789” of the user B5a to log in the processor with data encryption function 15 and creates processing directive data 112b by inputting the address (not shown) of the external device 2, an external device user ID (not shown) of the user B5b and an external device authentication password 203b “xyz” of the user B5b. The information inputted in this way is contained in the processing directive data 112b. The processing directive data 112b can be handled only by the user B5b in the processor with data encryption function 15.

Next, as is shown in FIG. 8C, the user B5b, who is the administrative user, fetches the processing directive data 112a of the user A5a and the processing directive data 112b of the user B5b into the administrative external device 3 from the processor with data encryption function 15. The processing directive data 112a and the processing directive data 112b are encrypted by the processing directive data encryption and decryption device 102 at the point in time at which they are outputted from the processor with data encryption function 15, and as is shown in FIG. 4, parts thereof which contain the external device authentication passwords 203a, 203b constitute encrypted parts 204a, 204b, respectively.

Note that the fetching operation of the processing directive data 112a, 112b into the administrative external device 3 is approved to be carried out by the administrative user for necessity of maintenance and backup of those pieces of data, and hence, this operation itself is not such as to constitute an unauthorized or illegal operation.

Next, as is shown in FIG. 8D, the user B5b copies the encrypted part 204a of the processing directive data 112a to replace the encrypted part 204b of the processing directive data 112b with the copy of the encrypted part 204a. Namely, although the user B5b cannot know the contents (the external device authentication password 203a “sesami” of the user A5a) of the encrypted part 204a, he or she can make use it by pasting it to the processing directive data 112b of the user B5b. In addition, the external device user ID (not shown) of the user B5b can also be replaced by the external user ID (not shown) of the user A5b.

This operation of replacing the encrypted part 205b by the encrypted part 204a and the operation of replacing the external device user ID of the user B5b by the external device user ID of the user A5a are illegal operations intended to execute the processing directive data 112b under the name of the user A5a.

Next, as is shown in FIG. 8E, the user B5b returns the processing directive data 112a and the processing directive data 112b of which the encrypted part 204b is replaced by the encrypted part 204a to the processor with data encryption function 15. The processing directive data 112a, 112b are decrypted by the processing directive data encryption and decryption device 102 at the point in time at which they are inputted into the processor with data encryption function 15. However, as done on the administrative external device 3, the contents of the processing directive data 112a, 112b cannot be read on the processor with data encryption function 15.

Next, as is shown in FIG. 8F, the user B5b attempts execute the processing directive data 112b using the processor with data encryption function 15, whereby the process based on the process contents described in the processing directive data 112b is executed, and meta data (image data, text data or the like) which contains, for example, the address (not shown) of the external device 2, the external device user ID (not shown) of the user A5a, and the external device authentication password 203a “sesami” of the user A5a is sent to the external device 2. Since the external device authentication password 203a “sesami” is the right password, the password is authenticated by the external device 2, and processing of the processing directive data 112b disguised as the data of the user A5a is executed under the name of the user A5a.

Next, a case will be described where the user B5b, who is the administrative user, attempts to perform the same illegal operations on the processor with data encryption function 1 according to the embodiment of the invention.

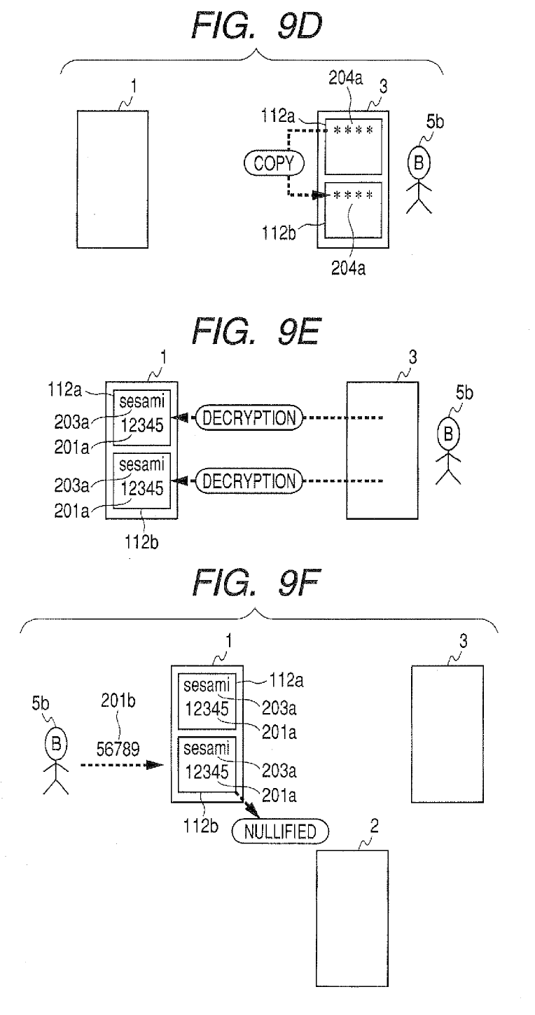

FIGS. 9A to 9F are conceptual diagrams showing an example of a processor with data encryption function according to the embodiment of the invention and an example of illegal operations performed on the administrative external device by the administrative user.

Firstly, as is shown in FIG. 9A, the user A5a inputs the device user ID 201a “12345” of the user A5b to log in to the processor with data encryption function 1 and then creates processing directive data 112a by inputting the address (not shown) of the external device 2, the external device user ID (not shown) of the user A5a and the external device authentication password 203a “sesami” of the user A5a. The information inputted in this way is contained in the processing directive data 12, and furthermore, as is shown in FIG. 3, an element containing a device user ID 201a is embedded in an element containing an external device authentication password 203a as a child element. The processing directive data 112a can be handled only by the user 5Aa in the processor with data encryption function 1.

Next, as is shown in FIG. 9B, the user 5Bb, who is the administrative user, inputs the device user ID 201b “56789” of the user B5a to log in the processor with data encryption function 1 and creates processing directive data 112b by inputting the address (not shown) of the external device 2, the external device user ID (not shown) of the user B5b and the external device authentication password 203b “xyz” of the user B5b. The information inputted in this way is contained in the processing directive data 112b, and furthermore, as is shown in FIG. 3, an element containing a device user ID 201b is embedded in an element containing an external device authentication password 203b as a child element. The processing directive data 112b can be handled only by the user B5b in the processor with data encryption function 1.

Next, as is shown in FIG. 9C, the user B5b, who is the administrative user, fetches the processing directive data 112b of the user A5a and the processing directive data 112b of the user B5b into the administrative external device 3 from the processor with data encryption function 1. The processing directive data 112a and the processing directive data 112b are encrypted by the processing directive data encryption and decryption device 102 at the point in time at which they are outputted from the processor with data encryption function 1, and as is shown in FIG. 4, parts thereof which contain the external device authentication passwords 203a, 203b constitute encrypted parts 204a, 204b, respectively.

Next, as is shown in FIG. 9D, the user B5b copies the encrypted part 204a of the processing directive data 112a to replace the encrypted part 204b of the processing directive data 112b with the copy of the encrypted part 204a. In addition, the external device user ID (not shown) of the user B5b is also replaced by the external device user ID (not shown) by the user A5a.

Next, as is shown in FIG. 9E, the user B5b returns the processing directive data 112a and the processing directive data 112b of which the encrypted part 204b is replaced by the encrypted part 204a to the processor with data encryption function 1. The processing directive data 112a, 112b are decrypted by the processing directive data encryption and decryption device 102 at the point in time at which they are inputted into the processor with data encryption function 1. However, as done on the administrative external device 3, the contents of the processing directive data 112a, 112b cannot be read on the processor with data encryption function 1.

Next, as is shown in FIG. 9F, the user B5b attempts execute the processing directive data 112b using the processor with data encryption function 1 by following the flow shown in FIG. 7. However, since the device user ID 201b “56789” inputted by the user B5b in step S11 in FIG. 7 does not coincide with the device user ID 201a “12345” which is embedded in the processing directive data 112, no authentication by the processing directive data executing user authentication device 103 is performed, whereby the processing directive data 112 is not executed (step S17 in FIG. 7).

### Other Embodiments

Note that the invention is not limited to the embodiment that has been described heretofore, and hence, the invention can be modified variously without departing from the spirit and scope of the invention. For example, the processor with data encryption function is not limited to the multifunction equipment but may be applied to any equipment which can deal with networking.

In addition, the encrypted part of the processing directive data is not limited to what is described in the embodiment above.

Additionally, the program that is used in the embodiment may be read into the storage of the processor from a storage medium such as a CD-ROM or may be downloaded into the storage of the processor from a server or the like which is connected to a network such as the internet.

In addition, while in the respective embodiments, the device user ID authentication device, the processing directive data generation device, the processing directive data encryption and decryption device and the processing directive data input/output device are realized by the CPU and the program, part of or all the devices may be realized by hardware such as an application specific integrated circuit (ASIC).

Additionally, the constituent elements of the respective embodiments can be combined in any way without departing from the spirit and scope of the invention.

What is claimed is:

1. A processor with encryption function comprising:
an input unit that inputs a user ID;
an embedding unit that embeds the user ID in an authentication password for access to a first external device, the authentication password being contained in processing directive data in which a processing content including access to the first external device is described;
an input/output unit that inputs and outputs the processing directive data to a second external device in response to a request from the second external device;
an encryption/decryption unit that encrypts the authentication password in which the user ID is embedded in a case where the input/output unit outputs the processing directive data, and that decrypts the authentication password in which the user ID is embedded in a case where the input/output unit inputs the processing directive data;
a processing unit that executes a processing based on the processing content described in the processing directive data;
a collating unit that collates the user ID inputted from the input unit with the user ID embedded in the authentication password in the processing directive data, in a case where the processing is executed, to verify whether or not the inputted user ID and the embedded user ID coincide with each other; and
an access unit that accesses the first external device in a case where the user ID inputted from the input unit and the user ID embedded in the authentication password in the processing directive data are determined to coincide with each other.

2. The processor with encryption function as claimed in claim 1, further comprising a user ID authentication unit that authenticates the user ID in a case where the user ID is inputted from the input unit.

3. The processor with encryption function as claimed in claim 1, further comprising a processing directive data generation unit that generates the processing directive data.

4. The processor with encryption function as claimed in claim 1, further comprising a storage that stores the processing directive data.

5. The processor with encryption function as claimed in claim 1, further comprising a communication interface that connects to a communication unit.

6. An encryption device comprising:
an embedding unit that embeds a user ID in a password; and
an encryption device that encrypts the password in which the user ID is embedded.

7. The encryption device as claimed in claim 6, wherein the password and the user ID are to be used to access external devices which are different from each other.

8. The encryption device as claimed in claim 6, wherein the password is contained in processing directive data in which a processing content including access to the external devices is described.

9. An encryption processing method comprising:
embedding a user ID in an authentication password for access to a first external device, the authentication password being contained in processing directive data in which a processing content including access to the first external device is described;
encrypting the authentication password in which the user ID is embedded, and outputting the processing directive data to a second external device in response to a request from the second external device;
inputting the processing directive data from the second external device, and decrypting the authentication password in which the user ID is embedded in response to a request from the second external device;
executing a processing based on the processing content descried in the processing directive data;
collating a user ID inputted from an input unit with the user ID embedded in the authentication password in the processing directive data, in a case where the processing based on the processing content is executed, to verify whether or not the inputted user ID and the embedded user ID coincide with each other; and
accessing the first external device in a case where the user ID inputted from the input unit and the user ID embedded in the authentication password in the processing directive data are determined to coincide with each other.

10. A computer readable medium storing a program causing a computer to execute a process for performing an encryption processing, the process comprising:
embedding a user ID in an authentication password for access to a first external device, the authentication password being contained in processing directive data in which a processing content including access to the first external device is described;
encrypting the authentication password in which the user ID is embedded, and outputting the processing directive data to a second external device in response to a request from the second external device;
inputting the processing directive data from the second external device, and decrypting the authentication password in which the user ID is embedded in response to a request from the second external device;
executing a processing based on the processing content descried in the processing directive data;
collating a user ID inputted from an input unit with the user ID embedded in the authentication password in the processing directive data, in a case where the processing based on the predetermined content is executed, to verify whether or not the inputted user ID and the embedded user ID coincide with each other; and
accessing the first external device in a case where the user ID inputted from the input unit and the user ID embedded in the authentication password in the processing directive data are determined to coincide with each other.
